(19) United States
(12) Patent Application Publication
(10) Pub. No.: US 2015/0298367 A1
(43) Pub. Date: Oct. 22, 2015

(54) METHOD AND APPARATUS FOR MANUFACTURE OF COMPOSITE ARTICLES

(71) Applicant: COUGAR COMPOSITES IP PTY LTD, Murphys Creek, Queensland (AU)

(72) Inventors: Dennis HART, Queensland (AU); Bradley HART, Queensland (AU); Winston HART, Queensland (AU); William HART, Queensland (AU)

(21) Appl. No.: 14/646,887

(22) PCT Filed: Nov. 22, 2013
(86) PCT No.: PCT/AU2013/001353

§ 371 Date: May 22, 2015

(30) Foreign Application Priority Data
Nov. 23, 2012 (AU) 2012905139

(51) Int. Cl. B29C 39/44; C08J 5/00; B29C 37/00; B29D 99/00; B29C 39/24; B29C 39/38

(52) U.S. Cl. CPC B29C 39/44; B29C 39/24; B29C 39/38; B29C 37/0075; B29D 99/0089; C08J 5/00; B29K 2031/00

(57) ABSTRACT

A process for forming composite articles includes the steps of delivering resin to a mixer at a pre-set flow rate; mixing the resin with a catalyst in the mixer to form a composite material; delivering a stream of the composite material to a mould; detecting variations in flow rate of the resin during delivery relative to a pre-set value of flow rate of the resin; and controlling delivery of the resin material to reduce the variations in flow rate of the resin during delivery.

### TECHNICAL FIELD

A method and an apparatus for manufacture of composite articles are disclosed, particularly although not exclusively articles requiring structural properties. In one aspect the apparatus includes an improved resin flow control system and method.

### BACKGROUND ART

Some current moulding systems for structural articles employ polyurethane using a honeycomb core structure. However, delamination is a problem with this polyurethane system since composites do not adhere well so that careful surface preparation is required to facilitate bonding. Thus the integrity of the bond is limited to the quality of surface preparation. It should be noted that bonding is limited to a mechanical nature as these materials do not bond chemically. The core material is also generally soft and thus also compresses easily.

Foam moulding systems, such as polyurethane or PVC, are commonly used in sandwich construction. PVC is generally considered superior to urethane, however it is quite expensive. These materials bond mechanically only and the foam surface tends to degrade ultimately leading to failure of the moulded item.

Balsa is commonly used as a supporting core. However, Balsa is dependent on the availability of the raw material. Compression strength of balsa is relatively good, and bonding—although good—again is only mechanical. In wet situations the balsa is subject to rot.

The above references to the background art do not constitute an admission that the art forms a part of the common general knowledge of a person of ordinary skill in the art. The above references are also not intended to limit the application of the apparatus and method as disclosed herein.

### SUMMARY OF THE DISCLOSURE

In an aspect there is provided a process for forming composite articles comprising the steps of delivering resin to a mixer at a pre-set flow rate; mixing the resin with a catalyst in the mixer to form a composite material; delivering a stream of the composite material to a mould; detecting variations in flow rate of the resin during delivery relative to a pre-set value of flow rate of the resin; and controlling delivery of the resin material to reduce the variations in flow rate of the resin during delivery.

In an embodiment, the variation includes decrease in flow rate of the resin material with reference to the preset flow rate value, wherein the decrease results in increasing the rate of delivering the resin.

In an embodiment the variation in flow rate of the resin is detected by sensing fluctuations in head pressure developed during the delivering of the composite material.

In an embodiment, the mould is movably positioned relative to the mixer.

In an embodiment, the process further includes heating the composite material contained in the mould to a temperature to facilitate curing of the composite.

In an embodiment, the process further includes controlling temperature of the composite material contained in the mould to maintain the polymerisation temperature to effect curing.

In an embodiment, the process includes sequentially cooling the composite material contained in the mould.

In an embodiment, the process includes applying a mould-release coating on a mold surface of the mould sequentially before the step of releasing the stream of the composite material into the mould.

In an embodiment, the process further includes releasing one or more composite articles formed in the mould.

In an embodiment, the process further comprises cutting the composite articles by contacting the composite articles with cutting edges; and piercing the composite articles with the cutting edges to form a plurality of cuts extending along a width of the composite article.

In another aspect, there is provided a resin flow control system comprising a selector to set a value corresponding to a pre-set flow rate for delivering resin to a mixer; a sensor to detect variations in flow of resin relative to the pre-set flow rate of resin; and a controller to receive a signal from the sensor and control the flow rate of resin to minimise the variation.

In an embodiment, the controller controls pumping of the resin for delivering the resin material to the mould.

In an embodiment, the sensor detects the variations by detecting fluctuations in head pressure of a pumping means pumping the resin.

In yet another aspect, there is provided a composite article moulding apparatus comprising a mixing chamber for mixing a resin and a catalyst to form a composite material; a pump for pumping the resin to the mixing chamber; a delivery mechanism for releasing the composite material from the mixing chamber to the mould; a detector for detecting and signalling variation of flow rate of resin with reference to a pre-set flow rate of resin; a controller for controlling the rate of delivery; wherein the controller is adapted to receive a signal of the variation from the detector and affect a change in rate of delivery of the resin to reduce the variation of the flow rate of resin.

In an embodiment, the mixing chamber forms a part of the delivery mechanism.

In an embodiment, the delivery mechanism is movably mounted on a first drive assembly.

In an embodiment, the controller controls rate of movement of the delivery mechanism relative to the mould.

In an embodiment, the delivery mechanism is movable across a width of the mould.

In an embodiment, the mould is movably positioned on a conveyor assembly in order to allow continuous moulding.

In an embodiment, the mould is conveyed in a plane that is substantially perpendicular to a plane of movement of the delivery mechanism.

In an embodiment, the controller controls a rate of movement of the conveyor assembly.

In an embodiment, the apparatus further includes an applicator assembly for applying a release agent to the mould.

In an embodiment, the applicator is movably mounted on a second drive assembly.

In an embodiment, the apparatus further includes a mould release assembly to facilitate release of the composite article from the mould.

In an embodiment, the mould release assembly includes a member positioned relative to the mould, said member being operable to apply a positive force on the composite article to facilitate the release of the composite article from the mould.

In an embodiment, the apparatus further comprises a heating assembly for selective application of heat to the composite material in the mould for polymerising the composite material.

In an embodiment, the apparatus further comprises a cutting mechanism for cutting the composite article; said cutting assembly including one or more blades with cutting edges for contacting and piercing the composite articles; the blade can be movably mounted on a third drive assembly.

In an embodiment, the cutting mechanism further includes a clamp to position the composite article relative to said one or more blades.

In another aspect, there is provided a dispenser for delivering a composite material composed of a first component and a second component, the dispenser comprising: a first passage for conveying the first component from a first inlet into a mixing chamber; a second passage for conveying the second component from a second inlet into a mixing chamber; a valve assembly to prevent flow of the first component and/or the second component into the first passage; and a biasing mechanism to provide a bias to the valve assembly, wherein in a neutral position the biasing mechanism provides a bias in a biasing direction against the direction of flow of the first component from the inlet into the mixing chamber. The first component can be a resin. The second component can be a catalyst.

In another aspect, there is provided a composite article when formed by a process described herein.

### BRIEF DESCRIPTION OF THE DRAWINGS

Notwithstanding any other forms which may fall within the scope of the apparatus and method as set forth in the summary, specific embodiments will now be described, by way of example only, with reference to the accompanying drawings in which:

FIG. 1 shows a view of the general layout of a first embodiment in the form of a moulding system for carrying out a continuous manufacturing process for producing composite articles;

FIG. 2 shows a schematic block diagram of a first section of the moulding system of FIG. 1 concerning composite mixing and delivery;

FIG. 3 shows a schematic block diagram of a second section of the moulding system of FIG. 2 concerning a controller with associated electrical and pneumatic sub-systems;

FIG. 4 shows a circuit diagram of the apparatus coupled to the controller;

FIG. 5 shows a side view of the composite delivery and mould transport sub-systems;

FIG. 6A shows an enlarged view of a mixing head of the composite delivery sub-system of FIG. 5;

FIG. 6B shows an enlarged view of a release agent applicator sub-system of FIG. 5;

FIG. 6C shows an enlarged view of a first/application end of a conveyer included in the mould transport sub-system of FIG. 5;

FIG. 6D shows an enlarged view of the mould release assembly of FIG. 5;

FIG. 6E shows an exploded sectional view of the mixing head of FIG. 6A;

FIG. 7 shows a perspective view of an embodiment of a cut-off assembly;

FIG. 8A is a plan view of a structural panel in the form of a honeycomb core manufactured in accordance with an embodiment of the present invention;

FIG. 8B is a perspective view of the honeycomb core manufactured in accordance with an embodiment of the present invention;

FIG. 9A is a schematic illustration of an apparatus U for carrying out Uniform Deflection Load Measurement testing;

FIGS. 9B and 9C depict uniform load testing results of testing panels;

FIG. 9D is a graphical comparison between applied load against midspan deflection of testing panels;

FIG. 10A is a schematic illustration of an apparatus L for carrying out Line Load Measurement of testing panels;

FIGS. 10B and 10C depict line load testing results of testing panel;

FIG. 10D is a graphical comparison of applied load against deflection of testing panels;

FIG. 11A is a schematic illustration of an apparatus P for carrying out point load test of testing panels;

FIGS. 11B and 11C depict load vs deflection characteristics for differing span lengths carried out on Panel 002 and Panel 004 respectively;

FIGS. 12A and 12C are a schematic illustration of apparatus F1 and F2 used to ascertain deflection as a result of load to a point of fracture;

FIG. 12B is a graph that plots characteristics of load applied against resultant deflection when span length is 1200 mm; and

FIG. 12D is a graph that plots characteristics of load applied against resultant deflection when span length is 460 mm.

### DETAILED DESCRIPTION OF SPECIFIC EMBODIMENTS

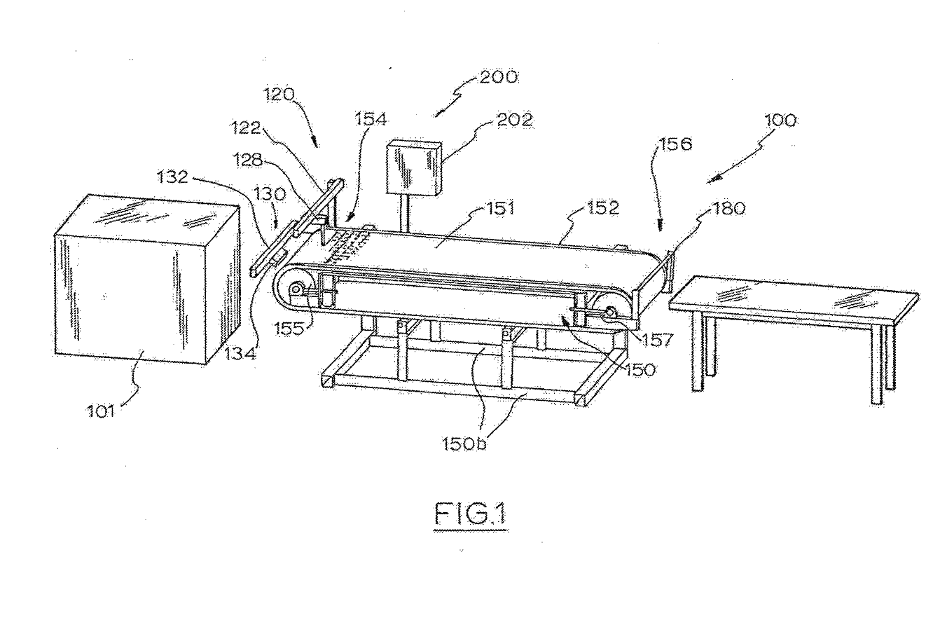

FIG. 1 illustrates the general layout of a moulding system 100 for continuous manufacturing of moulded composite articles in accordance with an embodiment of the invention. The moulding system 100 includes several mechanical, fluid delivery and pneumatic sub-systems which operate together under programmatic control. The system includes a pumping sub-system 101, a composite delivery sub-system 120, a release agent applicator sub-system 130, a mould transport sub-system 150, and a mould release assembly 180. Control of the moulding system 100 is effected by a processing apparatus, herein the form of a programmable logic controller (PLC) 202 interfaced to the above sub-systems, which itself is part of the electrical sub-system 200. Each of these and several other sub-systems will be described in detail below.

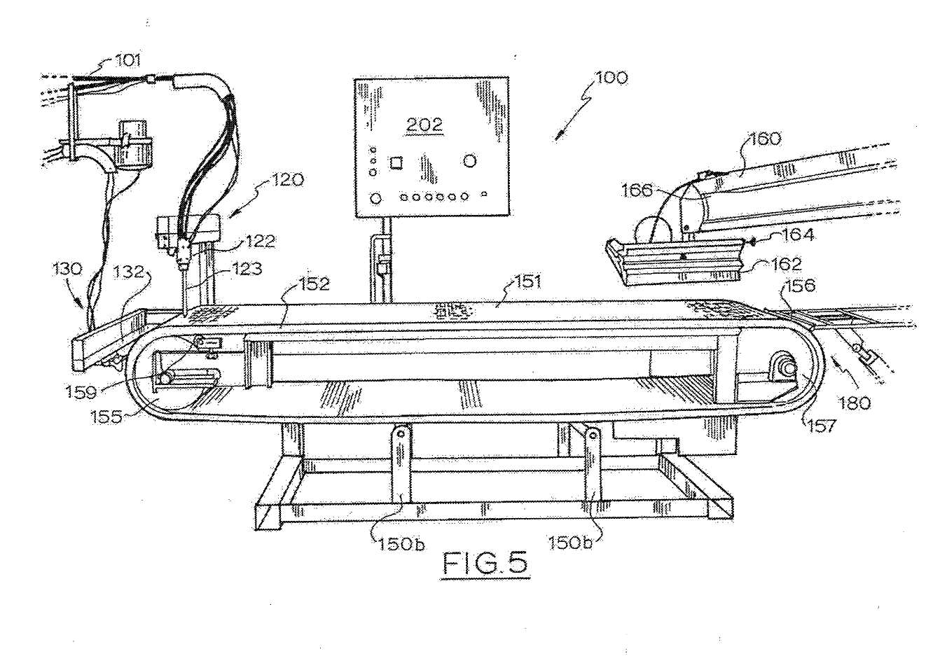

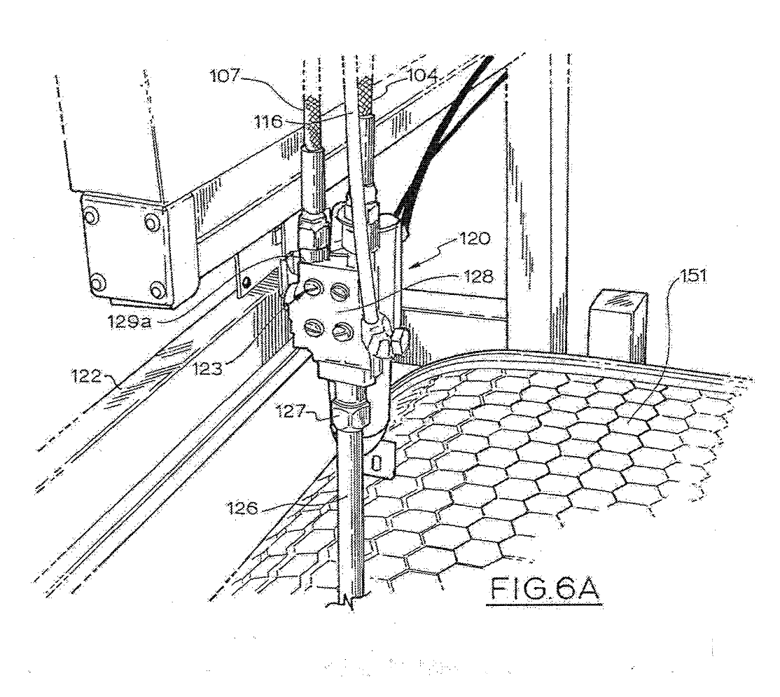

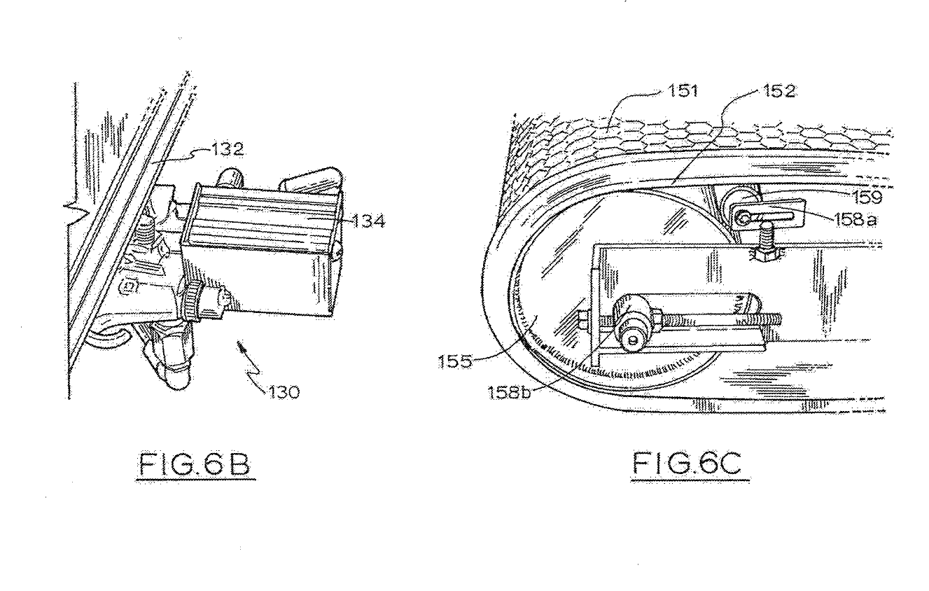

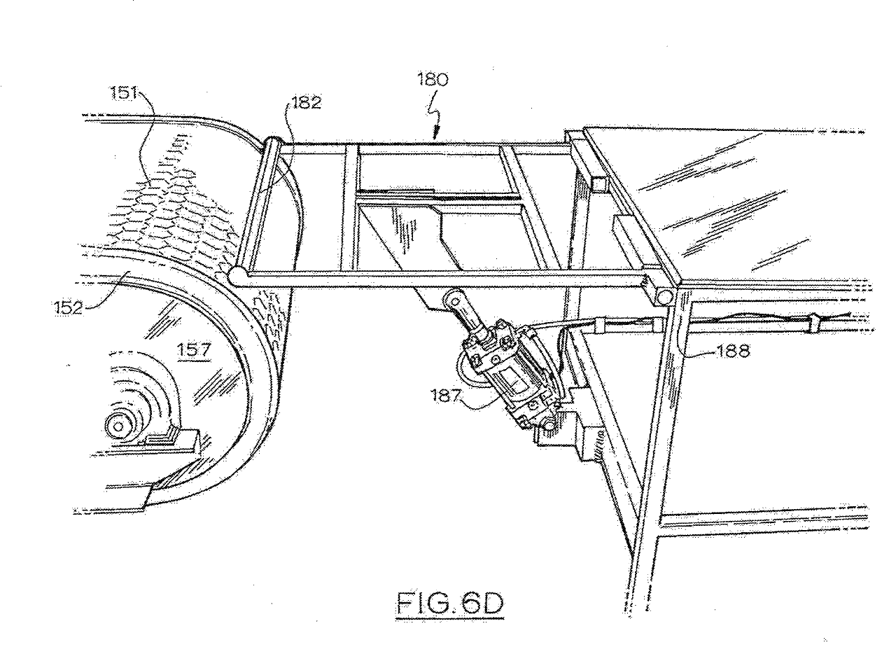

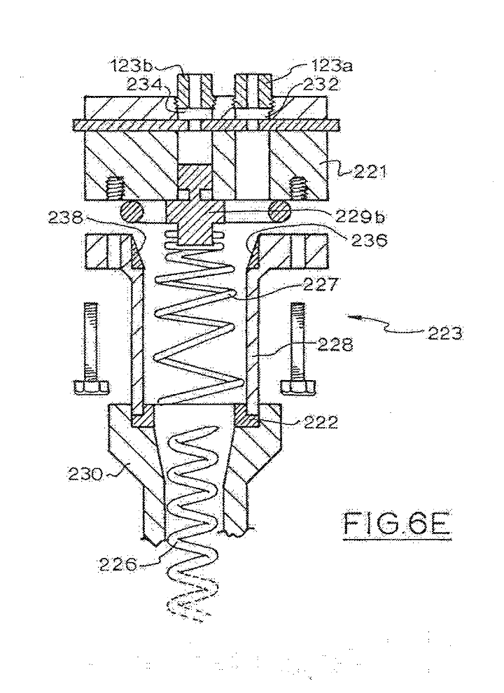

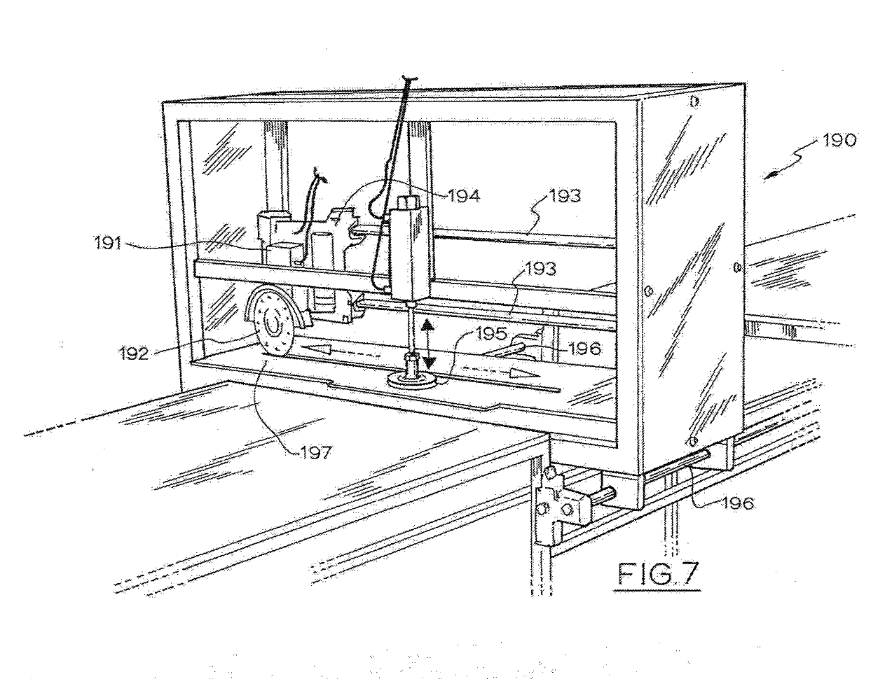

The mould transport sub-system 150 comprises a resilient mould 151 that is movably positioned on a conveyor assembly having a belt 152 which belt carries the resilient mould 151 between a first/application end 154 and a second/release end 156, over respective conveyor rollers 155, 157 mounted on a conveyor frame 150b. The resilient mould 151 may be fixed on the conveyor belt 152 by fastening means such as an adhesive, and thus is effectively continuous, as will be appreciated from the following discussion of the moulding process. Referring to FIG. 6C, the mould transport sub-system is shown in further detail. Advantageously the mould 151 of the present embodiment is constructed of silicone and is formed with tessellated cavities that resemble a honeycomb structure, here with cell size based on a 40 mm circle and upstanding lateral side walls. The upstanding lateral walls are resilient in nature. Resilience in the upstanding lateral walls enables widening of the tessellated cavities of the mould 151 on an application of a force such as a tensional force on the mould 151 by a tensioning roller 159. The mould transport sub-system 150 also includes a tension adjustment mechanism 158. A first adjustment mechanism 158a is used for optionally actuating the tensioning roller 159 into a tensioning position to exert tensional force along the length of the belt 152. A second adjustment mechanism 158B is used for further adjusting tension in the belt 152 by way of adjusting conveyor rollers 155 and 157.

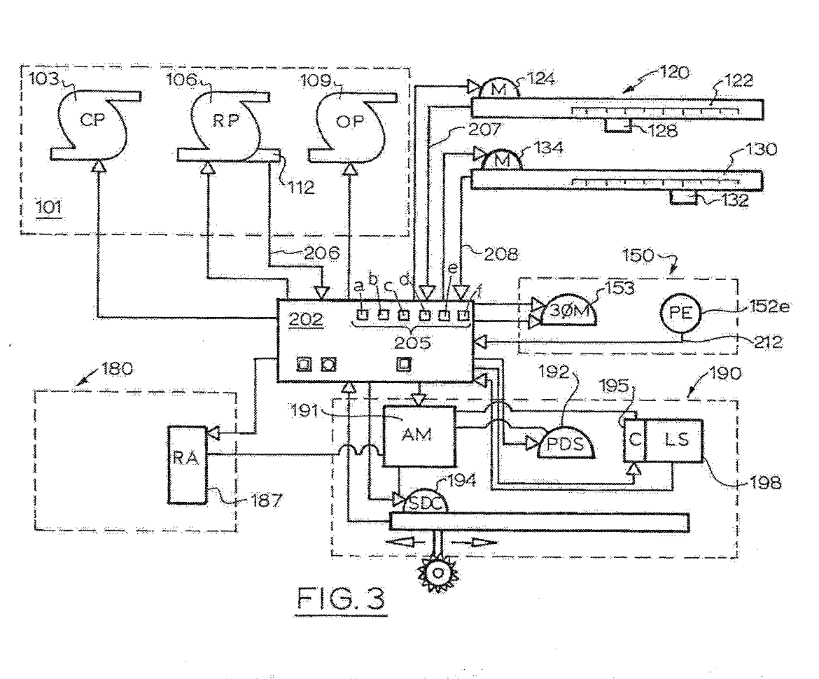

The pumping sub-system 101 is used for separately pumping and delivering a resin R and a catalyst C to the composite delivery sub-system 120. The composite delivery sub-system 120 includes a delivery gun 123. The gun 123 is provided with a first inlet 123a for receiving resin R and second inlet 123b for receiving a catalyst C. The gun 123 includes a body that forms a mixing chamber in the form of a mixing head 128. The pumping sub-system includes a resin pump 106 arranged to pump resin R from a resin reservoir 105 via a resin line 107. The pumping system also includes a catalyst pump 103 arranged to pump catalyst C from a catalyst reservoir 102 via a catalyst line 104. Referring now to FIG. 6A, the mixing chamber 128 receives resin R flowing through resin line 107 via inlet 123a. Similarly, the mixing chamber 128 receives catalyst C flowing through the catalyst line 104 via the second inlet 123b. The resin/catalyst composite is dispensed from the mixing head 128 through a static mixer 126, and a dispensing operation trigger is electronically controlled by the PLC (described further below). The first inlet 123a is provided with a first valve assembly in the form of a resin flow valve 129a that prevents back flow of composite material from the mixing head 128 into the resin line 107. Similarly the second inlet 123b is provided with a second valve assembly in the form of a catalyst flow valve 129b that prevents back flow of composite material from the mixing head 128 into the catalyst line 107. Furthermore, a chamber valve assembly in the form of a chamber valve 127 is positioned at an inlet of the static mixer 126 that prevents back flow of composite material from the static mixer 126 back into mixing head 128. The static mixer 126 is in communication with the mixing head 128. The static mixer 126 includes a mixing tube 126a. The static mixing tube 126A is composed of an inexpensive and lightweight plastic such as polyethylene or polypropylene. These materials ensure that the static mixing tube 126a does not add extraneous weight to the gun 123. Placed within the static mixing tube 126a and running the entire length of the tube 126a is a spiral mixer 126b (FIG. 3). The spiral mixer 126b is of a helical configuration with reversely flighted segments with each segment being reversely flighted from adjacent segments. This configuration is continued along the length of the spiral mixer 126b to allow homogenous mixing of the catalyst and resin as they pass through the static mixing tube 126a. The gun 123 also includes a third inlet 123c for feeding a cleaning solvent in the form of Acetone. After a composite delivery operation is completed residual composite material such as catalysed resin may remain in the mixing head 128 and the static mixer 126 and can often harden inside the mixing head 128 and/or the static mixer 126. Flushing the mixing head 128 and the static mixer 126 with Acetone by way of a flushing system F is therefore advantageous in removing the residual composite material from the mixing head 128 and static mixer 126.

FIG. 6E depicts a further embodiment of a dispenser for dispensing composite material in the form of a gun 223. The gun 223 includes a body 221 that forms a mixing chamber in the form of a mixing head 228. The mixing chamber 228 receives resin R flowing through resin line 107 via inlet 223a into a resin passage 232. Similarly, the mixing chamber 228 receives catalyst C flowing through the catalyst line 104 via the second inlet 223b into catalyst passage 234. The resin/catalyst composite is conveyed from the mixing head 228 through a static mixer 226 before being dispensed. The second inlet 123b is provided with a valve assembly in the form of a catalyst flow valve 229b that prevents back flow of composite material from the mixing head 128 into the catalyst line 107. A biasing mechanism in the form of a spring 227 is provided. The spring 227 provides a bias to the catalyst flow valve 229. In a neutral position the spring 227 provides a bias in a biasing direction that is against the direction of flow of the first component from the inlet into the mixing chamber. This direction of bias in the spring 227 is achieved by attachment of the spring to a part of the mixing chamber 228 by a spring retainer 222 mounted onto a mixer housing 230 forming the mixer chamber 228. The direction of bias applied on the valve by the spring 227 is particularly advantageous because it prevents the flow of material (including resin and/or catalyst) from the mixing chamber into the catalyst inlet 123b even whilst there isn't sufficient back pressure within the mixing chamber.

It should be appreciated that application of a conventional spring loaded valve assembled along the catalyst passage 234 includes a spring that is biased in a direction along the flow of the incoming fluid. As a result, conventional spring loaded valve assembly relies on sufficient back pressure within the mixing chamber 228 to activate and deploy the valve assembly that suitable prevents backflow of liquids (including resin and/or catalyst). In the absence of sufficient back pressure, there is a possibility of liquids (including resin and/or catalyst) seeping back into the catalyst passage 234. Such a flow of contents of the mixing chamber 228 is highly undesirable because it tends to build up along the walls of catalyst passage 234 eventually causing blockages that involve considerable maintenance.

Furthermore, flow characteristics of resin R and catalyst C flowing into the mixing chamber 228 are considerably improved by providing collar members 236 and 238 respectively. Collar member 236 and 238 are located at an intermediate location between the respective inlets (123a, 123b) and the mixing chamber 228. The collar members each include oblique surfaces that enable better flow of the resin R and catalyst C into the mixing chamber 228.

Delivery of composite material into the mould 151 at times may result in over flowing of the composite material from the individual tessellated cavities. A spreading sub-assembly 300 may be provided to spread the overflowing composite material to evenly distribute the overflowing composite material to other tessellated cavities on the mould. The scraping sub-assembly 300 may be provided with a spreading member 310 that may be manually operated or advantageously actuated by a motor controlled by the PLC 202.

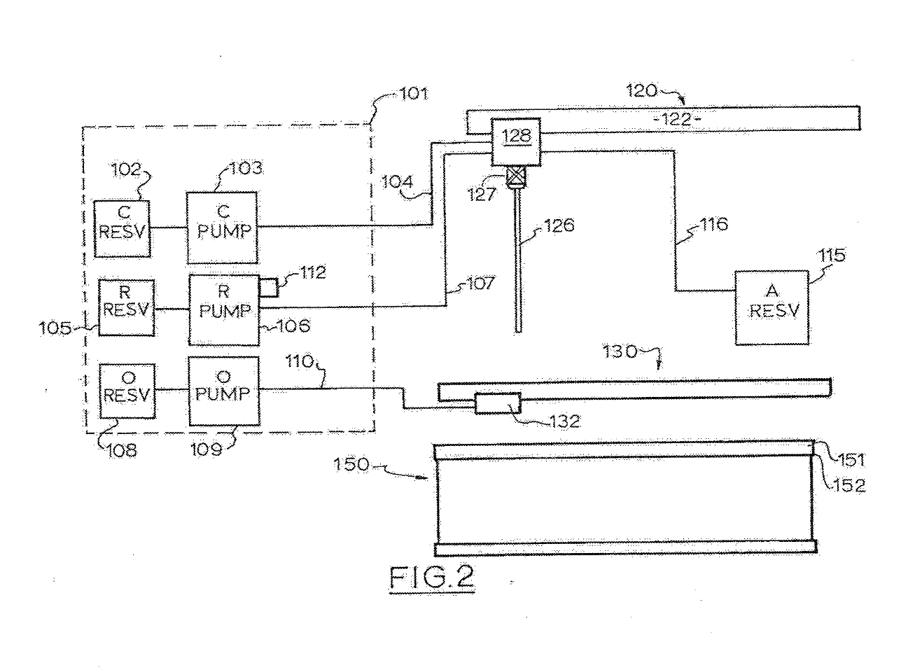

Turning to FIG. 2, the composite delivery sub-system 120 further includes a drive assembly in the form of a composite delivery rail 122 upon which the gun 123 including the static mixer 126 are movably mounted. In particular, the rail is arranged transversely to longitudinal travel of the mould 151. The composite delivery sub-system 120 is controlled by the PLC 202, such that a desired supply of both resin R and catalyst C are delivered to the mixer head 128 and then received in the static mixer 126 before being released into the mould 102. The composite delivery system 120 is movably carried on composite delivery rail 122 that is positioned across the width of the conveyor belt 152, enabling movement of the composite delivery sub-system in a direction that is substantially perpendicular to the travel of the conveyor belt 152.

FIG. 3 is a schematic block diagram of a second section of the moulding system 100 showing the PLC 202 together with associated electrical and pneumatic sub-systems. The PLC 202 includes a process start button 203 and a process stop button 204, together with a series of further buttons 205a to 205 g relating to specific functions that will become clear through the course of this section. Activation button 205d activates the catalyst pump 103 and resin pump 106. Each of the catalyst pump 103, the resin pump 106 and the release oil pump 109 are controlled by outputs from the PLC 202, the resin pump 106 being notable in including a delivery rate sensor 112 which feeds a resin feed rate signal 206 back to the PLC. In the embodiment, the rate delivery sensor takes the form of a detector that measures a speed of a plunger that executes a discharge stroke in a pumping action of the resin pump 106. The metal detector thereby detects variations in head pressure developed by the resin pump 106 during the course of delivering resin R. The mixing head 128 of the composite delivery sub-system 120 is driven by a motor 124 controlled by the PLC 202, wherein position of the mixing head on the rail 122 is detected by a delivery position sensor 125 and fed back to the PLC in the form of a composite head position signal 207. The composite delivery sub-system 120 is activated by activation button 205e and thereby controlled by the PLC 202. Similarly, the oil applicator head 132 of the release agent sub-system 130 is driven by a motor 134 controlled by the PLC, wherein position of the applicator head is detected by an applicator position sensor 135.

Turning to the mould drive sub-system 150, the PLC 202 controls an AC motor drive 210 and associated electrical motor 211 of the conveyor belt drive 153. Conveyor belt speed is monitored by a belt encoder 153e, which feeds a belt speed signal 212 back to the PLC. Activation button 205a in conjunction with the PLC 202 activates the AC motor drive 210.

A release agent sub-system 130 is provided to facilitate release of the moulded composite article from the mould. The release agent sub-system includes a release agent applicator 132 that receives a release agent in the form of oil from an oil reservoir 108. The oil from the oil reservoir 108 is pumped by oil pump 106 via line oil line 110 into the release agent applicator 132. The release agent applicator 132 is used for applying the oil to the mould before any composite material is received from the static mixer 126 into the mould 151. Application of the release agent prior to delivery of composite material into the mould 102 prevents adhesion of the moulded composite article in the mould 102. Advantageously, the applicator 132 is driven by an applicator drive motor 134 on a drive assembly in the form of an applicator rail assembly 136. The applicator rail assembly 136 is positioned relative to the composite delivery rail 122 to enable sequential application of release agent to the mould 102 positioned on the conveyor belt 152 before the release of composite material into the mould 102. Activation button 205b in conjunction with the PLC 202 activates the release agent sub-system 130 by activating the oil pump 106.

A heating assembly 160 is provided for application of heat to the composite material contained in the mould. The heating assembly 160 in the preferred embodiment includes Ultra-violet lamp elements 162 and 164 positioned at an end of a retractable arm 166 connected to an upright support 165. In alternative embodiment, a heating assembly 160 with heating elements 163 may also be provided in a space underneath the conveyor belt and be housed within the conveyor assembly 150 to optionally heat the contents of the mould to a polymerisation temperature.

A cooling assembly 170 in the form of an air circulator 172 may also be provided to cool the contents of the mould after polymerisation of the contents of the mould has occurred. In the preferred embodiment the contents of the mould may be air cooled by atmospheric air circulated by an air circulator, such as a fan.

A mould release assembly 180 is provided at the second/release end 156. The mould release assembly 180 consists of a supporting frame 182 with a member in the form of a release bar 184 that is positioned relative to the mould 102 and relative to the conveyor belt 152. The supporting frame 182 is pivotally mounted on a release support structure 188. A release actuator 187 is connected to the release frame 182 by a connecting arm 189. The release actuator 187 is actuated by the mould release motor 183 may be optionally activated to pivot the supporting frame 182 in order to engage the moulded composite article in the mould 102 and thereby apply a positive upward force on the moulded composite article to facilitate release of the composite article from the mould 102. Release of the composite article is thus facilitated by the mould release assembly 180 and continuous motion of the conveyor belt results in the released composite article being transferred from the mould 102 on to the supporting frame 182.

A cutting mechanism in the form of a cut-off assembly 190 is also provided for cutting a moulded composite article into smaller units. The cut-off assembly 190 includes a pneumatic docking saw 192. The cutting elements of the docking saw 192 are driven by an air motor 191 that uses compressed air to drive the cutting elements of the docking saw 191. The docking saw 192 is supported on transverse saw rail 193. The air motor 191 pneumatically drives the docking saw along the saw supporting tracks 193. Provision of the docking saw 192 on saw rail 193 enables movement of the cutting elements along the direction of the rail 193 relative to the composite article placed on a working surface 197. Such a movement results in contacting and piercing through the moulded composite article to cut the composite article into smaller units. Advantageously, the cut-off assembly also includes a clamp 198. The clamp 198 may be actuated to clamp the composite article against the working surface 197 to further prevent movement of the composite article whilst the composite article is contacted by the docking saw 192 in a cutting operation. The cutting assembly 190 is movably mounted on a pair of saw support tracks 193 that enable movement of the cutting assembly to adjust positioning of the cutting assembly 190.

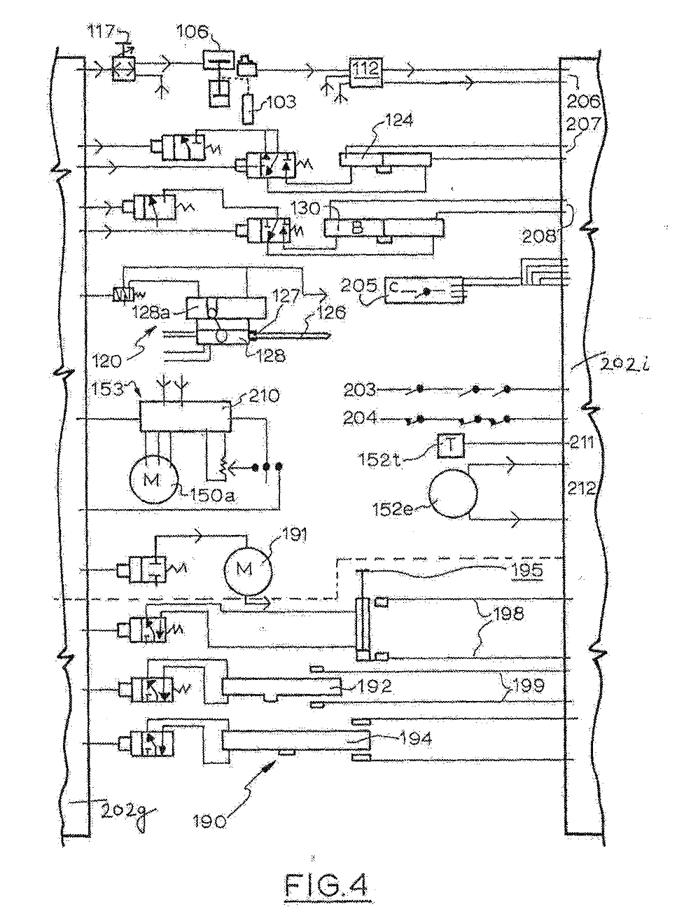

The process of moulding composite articles using the moulding system 100 includes operation of the pumping system 101 under programmatic control of the PLC 202. With reference to FIG. 4, control signals generated by the PLC are indicated at 202g, whilst the feedback signals received by the PLC are indicated at 202i. Prior to commencing a continuous manufacturing process operation a value corresponding to a pre-set value of flow rate for the flow of the resin R via line 122 is entered into the PLC 202 through an input. This input can be manually changed. Activation button 205f is used for incrementing the pre-set rate of flow of the resin R and activation button 205g is used for decrementing the pre-set rate of flow. The process start button 203 is activated and the manufacturing process is thereby commenced. During the course of pumping resin R to the mixer head 128 variations in the flow rate of resin R in the form of changes in the rate of flow of resin R due to issues such as resin line blockages, resin build up etc effect a variation in head pressure developed by the resin pump 106. The resin delivery rate sensor 112 measures relative changes in head pressure developed by the resin pump 106. The delivery rate sensor 112 is a detector that measures a speed of a metallic plunger that executes a discharge stroke in a pumping action. Any variations in the flow rate of the resin R due to the aforementioned changes in flow rate result in a variation in the speed of discharge stroke. The delivery rate sensor 112 monitors the speed of the plunger by way sensing number of pulses per discharge stroke of the plunger during a pumping operation whilst resin is delivered to the mixer head 128. The delivery rate sensor 112 thereby continuously sends the resin flow feedback signal 206 to the PLC 202. The resin flow feedback signal 206 is indicative of the flow rate of the resin R during a pumping operation to the PLC 202. The PLC 202 receives the resin flow feedback signal 206 and compares that signal 206 with the pre-set value of the flow rate of resin R. The PLC 202 is programmed for increasing the rate of pumping the resin R through the resin pump 106 when there is a difference between the flow rate of the resin through resin flow feedback signal 206 and the pre-set resin flow rate value. Specifically, the PLC 202 is programmed for sending a signal to an air regulator 117 to increase the power of an air motor that drives resin pump 106. This results in increasing the rate of pumping of the resin R. The rate of pumping of the resin pump 106 (an air pump) 106 is thus increased by the air regulator 117 when a decrease in flow rate of the resin R in comparison with the pre-set value of flow rate is detected by the delivery rate sensor 112. The PLC 202 is also programmed for decreasing the rate of pumping the resin R through the resin pump 106 when any increase in flow rate of the resin R in comparison with the pre-set value of the flow rate of resin is detected by the delivery rate sensor 112. Therefore, the continuous feedback signal of the head pressure detected by the delivery rate sensor 112 with any variations developed in the head pressure triggers controlling of the rate of pumping in order to minimize the variation in head pressure during delivery.

Operation of the pumping system 101 under programmatic control of the PLC 202 on activation of the process start button 203 also results in pumping catalyst C to the mixer head 128. The PLC 202 sends a catalyst activation signal to the catalyst pump 103 to pump the catalyst C from the catalyst reservoir 102 via catalyst line 104 into the second inlet of the mixer head 128. It is to be appreciated by a skilled person that the rate of flow of catalyst C being pumped by catalyst pump 103 may be varied by way of varying a rate of pumping of the catalyst C. Simultaneous pumping of catalyst C by catalyst pump 103 and pumping of resin R by resin pump 106 results in delivery of the catalyst and resin respectively into mixing head 128 on being activated by the PLC 202 by activating the process start button 203.

Advantageously, when the process start button 203 is triggered, the delivery system drive motor 124 is also activated which results in movement of the gun 123 from a first end of the delivery rail 122a to a second end 122b of the delivery rail 122. Such a movement of the gun 123 whilst it releases composite material from the static mixer 126 is particularly useful because it results in delivery of composite material across a width of the mould 151.

Advantageously, release agent sub-system 130 may also be activated by the PLC 202. The PLC 202 is programmed to optionally trigger the release of release agent from the release agent applicator 132 before any composite material is received in the mould. The PLC 202 is also programmed to activate the applicator drive motor 134 to drive the release agent applicator 132 on the applicator rail assembly 136 while release agent is sprayed/atomized on an inner surface of the mould 151. The PLC 202 also receives a signal from a position sensor 135 that senses instantaneous position of the release agent applicator 132 on the applicator rail assembly 136. In a typical release agent sub-system under operation, the release agent applicator 132 is driven by the applicator drive motor 134 on the applicator rail assembly 136 from a first end of the applicator rail assembly 136A to a second end of the applicator rail assembly 136B. The position sensor 135 sends a signal to the PLC 202 when the release agent applicator 132 reaches either end 136a or 136b and direction of movement for the release agent applicator is reversed. The PLC 202 may be programmed to commence activation of the release agent sub-system 130 prior to activation of the composite delivery sub-system 120. Furthermore, a pre-set time period between activation sequential activation of the release agent sub-system 130 and then composite delivery sub-system 120 may be programmed into the PLC 202. Such programming of the PLC 202 enables application of the release agent to an inner surface of the mould 151 before composite material is delivered into the mould 151.

The PLC 202 may also be programmed for controlling the mould transport sub-system 150. Actuating the process start button 203 on the PLC 202 also activates the belt drive motor 150a. Activation of the belt drive motor 150a enables movement of the resilient mould 151 from the first application end 151 to the second release end 156. It is important to appreciate that the resilient mould 151 is positioned on the conveyor belt 152 that is driven by the drive motor 150A on the first roller 155 and the second roller 157. A conveyor belt encoder 152e acts as a sensor for determining position and speed of the conveyor belt 152 and send a feedback signal 212 back to the PLC 202. It is to be appreciated by a skilled person that the PLC 202 may be optionally programmed to set the conveyor belt 152 at a pre-set speed. Furthermore, tensioning roller 159 may be actuated by way of an electronic signal from the PLC 202 to apply a tensional force on the resilient mould that result in stretching of the lateral upstanding walls of the resilient mould 151. Application of such a tensional force results in an increase in volume in the tessellated cavities of the resilient mould 151 thereby facilitating delivery of the composite material when the delivery sub-system is activated.

Controlling temperature of the composite material that includes resin R and catalyst C is important to facilitate curing and polymerization of the composite material received in the mould. The PLC 202 may be programmed to receive a signal 211 for conveyor belt temperature T from the conveyor belt temperature sensor 152t. The belt temperature signal 211 may be compared to a pre-set temperature value. It is important to note that a pre-set temperature may be manually entered into the PLC 202. The PLC 202 may also be programmed to optionally activate the heating assembly 160 when the temperature T is lesser than the pre-set value of temperature. Activation of the heating assembly would result in activation of the heating elements 162 and 164 that would thereby result in an increase in belt temperature T of the conveyor belt. Similarly, the PLC 202 may also be programmed to activate the cooling assembly 170 when the conveyor belt temperature T sensed by the conveyor belt temperature sensor 152t is greater than the pre-set value of temperature. Therefore, the PLC 202 may be programmed in conjunction with the heating assembly 160 and the cooling assembly 170 to act as a temperature control mechanism. It is to be appreciated by a skilled person that the heating elements 162, 164 and the cooling elements 172 may take several forms and are in not restricted to UV heating lamps and air circulators respectively.

After polymerisation of the composite material contained in the mould 151 has occurred, the mould 151 is conveyed to the second end 156 of the conveyor assembly 150. The PLC 202 may be programmed to activate the mould release assembly 180 when the mould 151 is positioned at the second end/release end 156 of the mould transport system 150. Advantageously, the positioning of the mould 151 at the second end 156 may be detected by the belt encoder 152E and a signal may be received by the PLC 202. Activation of the mould release assembly 180 triggers the mould release motor 183 that activates the release actuator 187 and thereby engages the release frame 182 with the moulded composite article formed in the mould 151. A positive force is applied by the release frame 182 on the composite article contained in the mould and transfers the released moulded item onto the supporting frame 182.

The cut-off assembly 190 may also be activated by the PLC 202 once the composite article is transferred from the supporting frame 182 on to the working surface 197. Activating the cut-off assembly 190 would result in triggering the air motor 191 that drives the pneumatic docking saw 192 and engages the cutting elements of the pneumatic docking saw 192 with the composite articles. Activating the air motor 191 also results in driving the pneumatic docking saw 192 along a direction of the rail saw supporting rail 193 that enables contacting and piercing of the composite article with the cutting elements of the pneumatic docking saw 192. Optional activation of the clamp 198 to clamp the composite article against the working surface 197 prevents movement of the composite article whilst the composite article is contacted by the docking saw 192 in a cutting operation. Advantageously the entire cut off assembly 190 is movably mounted on tracks 196 that enables moulded articles of varying lengths to be cut off as desired.

It is to be appreciated by a skilled person, that a filler material may be added to the resin in desirable embodiments of the invention. In a non-limiting example the filler material may be added to the resin in the resin reservoir.

It is also to be appreciated by a skilled person that the aforementioned process, the resin flow control system and the composite article moulding apparatus may utilize a variety of resins, fillers, catalysts and release agents based upon the desired characteristics of the composite article being manufactured.

Furthermore, it is important to appreciate that whilst the non-limiting embodiments and examples relate to a mould being in the form of a tessellated cavities in a honeycomb structure, the process disclosed is no way limited to moulds of this particular shape and moulds of any size, shape or form, such as triangular, quadrangular, pentagonal, may be used in conjunction with the process as described in the aforementioned sections.

### Example 1

A non-limiting example of a composite article manufactured by the process described in the preceding sections shall now be illustrated by way of example only.

A resilient silicone mould formed with tessellated cavities that resemble a honeycomb structure is used for moulding a honeycomb shaped core composite article. The resilient silicone mould is provided with a cell size based on a 40 mm circle and tessellated cavities with upstanding lateral side walls having a depth of 25 mm. The overall length of the silicone mould is 3000 mm and the overall width of the mould is 600 mm.

A mixture of Vinyl ester resin and milled glass is pumped by the resin pump. The resin pump is a positive displacement air pump with a ratio 10:1. The pump operates at a range of pressures between 15 to 30 PSI. into the into the composite delivery sub-system. MEKP (methyl ethyl ketone peroxide) is used as a catalyst is pumped to attain a ratio in the range of 0.5 wt % to 4 wt % of resin composition in the composite delivery sub-system. Release agent in the form of Canola oil facilitates mould release and is applied the release agent sub-system at a rate of approximately 4 ltr per 100 m² of the silicone mould.

The mould transport-subsystem is operated with a conveyor belt speed in the range of 250 mm/minute to 800 mm/minute. The temperature control system including the heating assembly and the cooling assembly control the temperature of the composite material contained in the mould in the range of 20 to 25° C. The belt temperature is also maintained in the range of 20 to 25° C. Temperatures beyond 75° C. need to be prevented to prevent damage to the silicone mould.

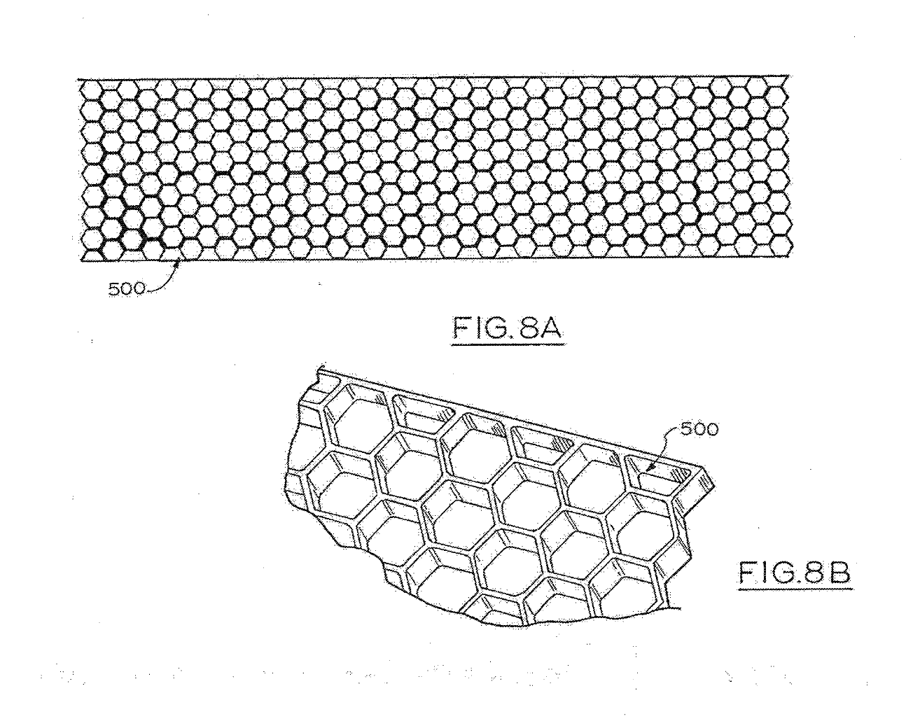

A honeycomb core 500 produced by the process of example 1 is shown in FIGS. 8A and 8B. The honeycomb shaped core may employ a liquid fibre reinforced composite that can be easily delivered into a mould. The honeycomb core is not subject to osmosis, rot, corrosion, insect attack, and is resistant to a wide range of chemicals. Cores can be manufactured to suit specific jobs that have a changing profile Shape & strength requirements. The composition of the liquid composite poured into the mould can be varied so that the properties of the honeycomb core are adjusted to suit different applications. The honeycomb core was produced by the method described in the preceding sections by using commercially available vinyl ester resin in the form of liquid composite MIR-100 manufactured by MIRteq Australia Pty Ltd.

Six (6) specimens of the honeycomb core were produced in a like manner to that of the preceding sections was made using commercially available vinyl ester resin in the form of liquid composite MIR-100. Tensile strength measurements for these specimens was carried out. The dimension of each analysed sample was 600 mm×600 mm with an MTS Insight Material Testing system. Results of the tensile strength measurements are set forth in Table 1.

TABLE 1

| | | | | Peak | Shear | Modulus of |
|---|---|---|---|---|---|---|
| Specimen | Width | Length | Area | Load | Stress | Elasticity |
| # | mm | mm | mm\hat{ }2 | N | MPa | MPa |
| 1 | 50.00 | 245.00 | 12250 | 26018 | 2.12 | 203 |
| 2 | 50.00 | 245.00 | 12250 | 33381 | 2.72 | 192 |
| 3 | 50.00 | 244.00 | 12200 | 31555 | 2.59 | 167 |
| Mean | 50.00 | 244.67 | 12233 | 30318 | 2.48 | 187.3 |
| Std Dev | 0.00 | 0.58 | 29 | 3834 | 0.31 | 18.4 |

Three (3) specimens of the honeycomb core were produced in a like manner to that of the preceding sections was made using commercially available vinyl ester resin in the form of liquid composite MIR-100. Shear strength measurements for those specimens was carried out with an MTS Insight Material Testing system. The dimension of each analysed sample was 250 mm×250 mm. Results of the shear strength measurements are set forth in Table 2.

TABLE 2

| | | | | | Peak | Peak | Peak | Compression |
|---|---|---|---|---|---|---|---|---|
| Specimen | Height | Width1 | Width2 | Area | Load | Stress | Strain | Modulus |
| # | mm | mm | mm | mm\hat{ }2 | N | MPa | % | MPa |
| 1 | 27.30 | 53.75 | 51.01 | 2742 | 32279 | 11.77 | 4.16 | 359.9 |
| 2 | 27.37 | 51.27 | 49.13 | 2519 | 26474 | 10.51 | 3.84 | 341.6 |
| 3 | 27.44 | 49.44 | 49.12 | 2428 | 20680 | 8.52 | 2.93 | 342.7 |
| 4 | 27.74 | 51.16 | 51.32 | 2626 | 23485 | 8.94 | 3.34 | 316.5 |
| 5 | 27.39 | 53.08 | 51.79 | 2749 | 26521 | 9.65 | 3.42 | 326.5 |
| Mean | 27.45 | 51.74 | 50.47 | 2613 | 25888 | 9.88 | 3.54 | 337.4 |
| Std Dev | 0.17 | 1.71 | 1.26 | 140 | 4315 | 1.30 | 0.47 | 16.6 |

Five (5) specimens of the honeycomb core were produced in a like manner to that of the preceding sections was made using commercially available vinyl ester resin in the form of liquid composite MIR-100. Compression strength measurements for 5 of these specimens were carried out with an MTS Insight Material Testing system. The dimensions of each analysed sample were 50 mm×50 mm×27 mm. Results of the shear strength measurements are set forth in Table 3.

TABLE 3

| | Peak | Peak | Modulus of | Poisson's |
|---|---|---|---|---|
| Specimen | Load | Stress | Elasticity | Ratio |
| # | N | MPa | MPa | mm/mm |
| 1 | 10112 | 168.55 | 11683 | 0.382 |
| 2 | 9923 | 117.01 | 12287 | 0.476 |
| 3 | 10277 | 169.76 | 12409 | 0.462 |
| 4 | 9982 | 185.87 | 11756 | 0.408 |
| 5 | 10463 | 171.69 | 12127 | 0.325 |
| 6 | 10799 | 178.35 | 12174 | 0.312 |
| Mean | 10259 | 175.20 | 12073 | 0.394 |
| Std Dev | 330 | 6.53 | 291 | 0.068 |

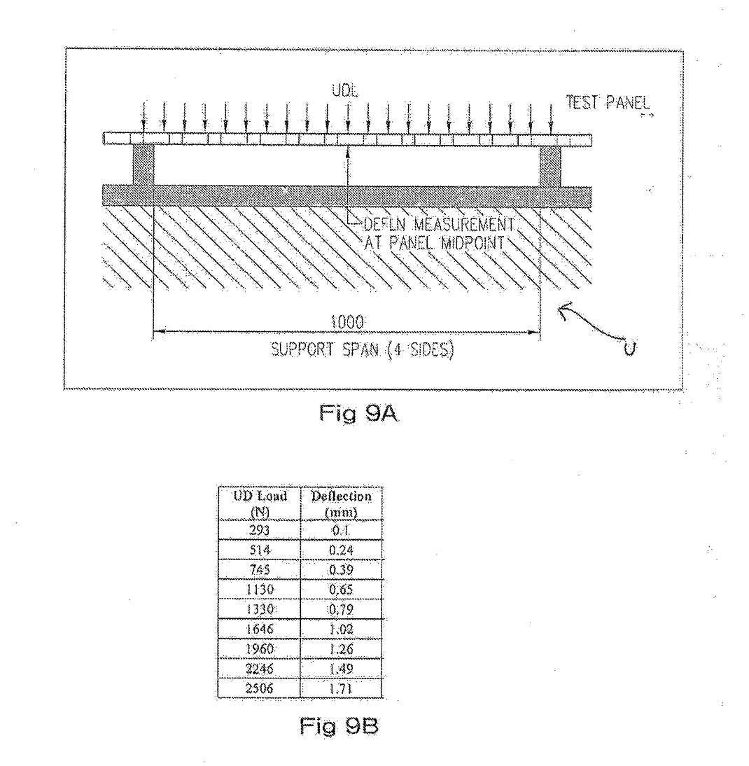

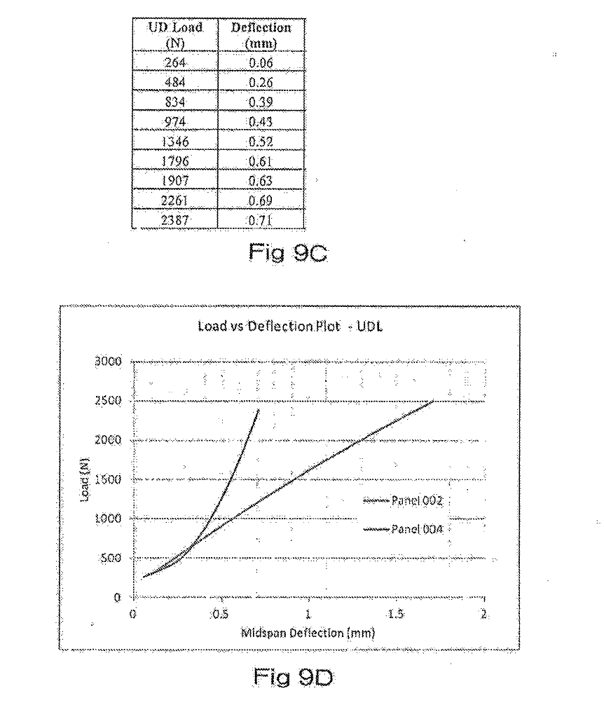

A first specimen honeycomb core testing panel “Panel 002” with a core wall thickness of 2 mm and second specimen honeycomb core testing panel “Panel 004” with a core wall thickness of 4 mm was made using commercially available vinyl ester resin in the form of liquid composite MIR-100. The dimensions of the panel were chosen to be 1200 mm×1200 mm. A uniform load test was carried by way of utilising uniform load testing apparatus U, as schematically illustrated in FIG. 9A. FIG. 9B is a table depicting uniform load testing results of the first testing panel, Panel 002. FIG. 9C is a table depicting uniform load testing results of the second testing panel, “Panel 004”. FIG. 9D illustrates a graphical comparison plotting applied load against midspan deflection of the first testing panel, Panel 002 and the second testing panel, Panel 004.

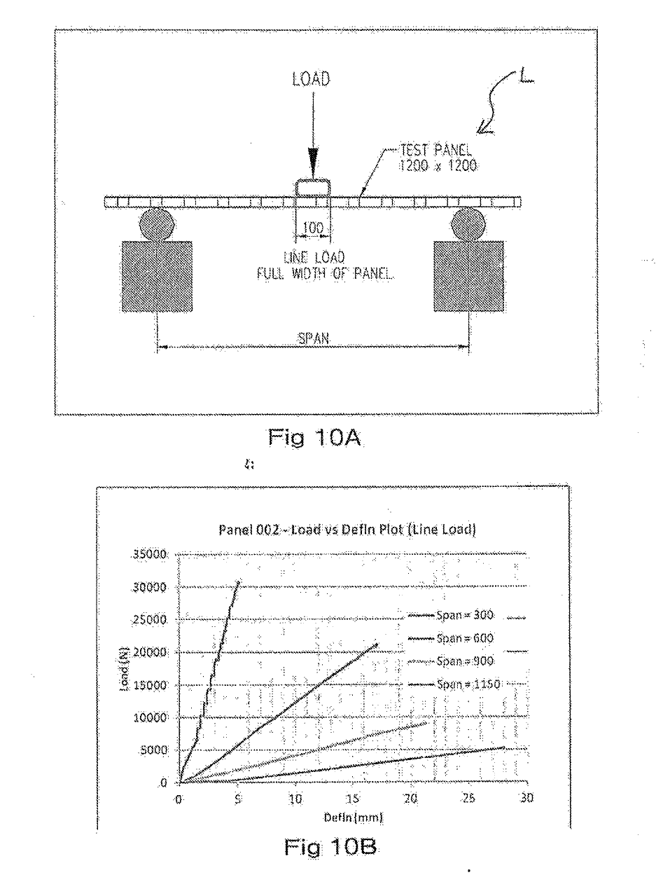

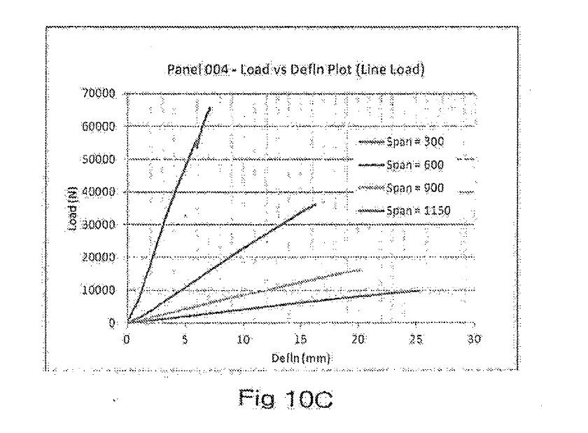

Furthermore, a line load test using apparatus L schematically illustrated in FIG. 10A was carried on Panel 002 and Panel 004. FIG. 10B is a table depicting line load testing results of the first testing panel, Panel 002. FIG. 10 C is a table depicting line load testing results of the second testing panel, Panel 004. FIG. 10D illustrates a graphical comparison plotting applied load against deflection of the first testing panel, Panel 002 and the second testing panel, Panel 004.

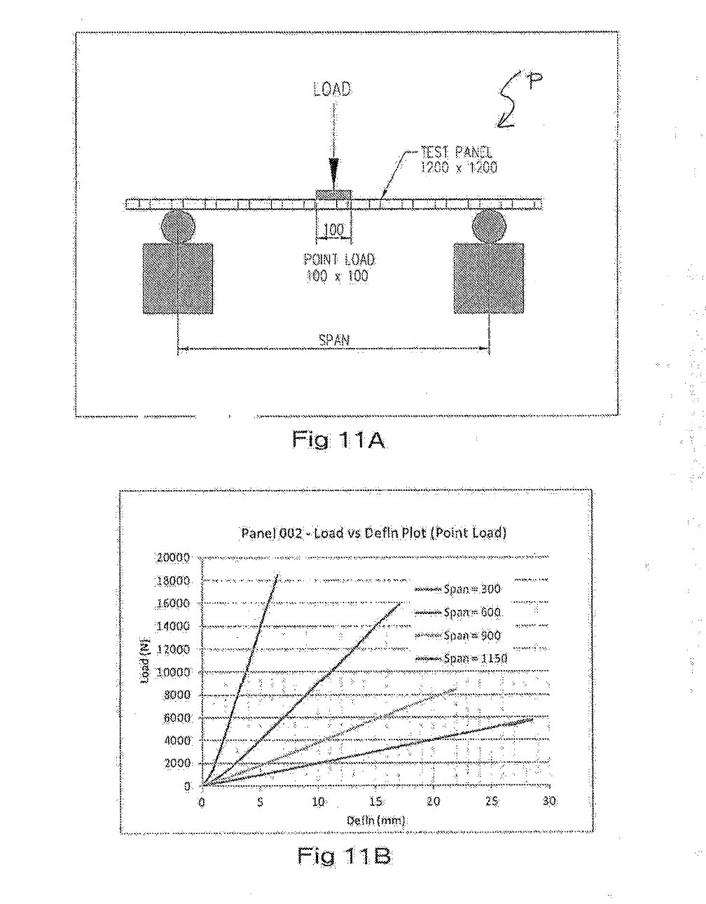

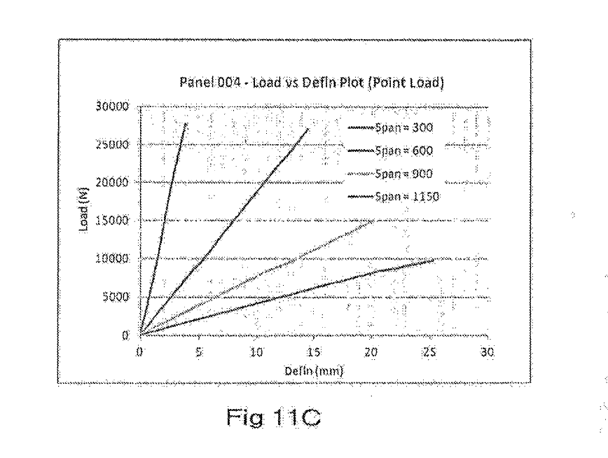

Furthermore, a point load test using apparatus P schematically illustrated in FIG. 11A was carried out on Panel 002 and Panel 004. FIGS. 11B and 11C are a graphical illustration of load vs deflection characteristics for differing span lengths carried out on Panel 002 and Panel 004 respectively.

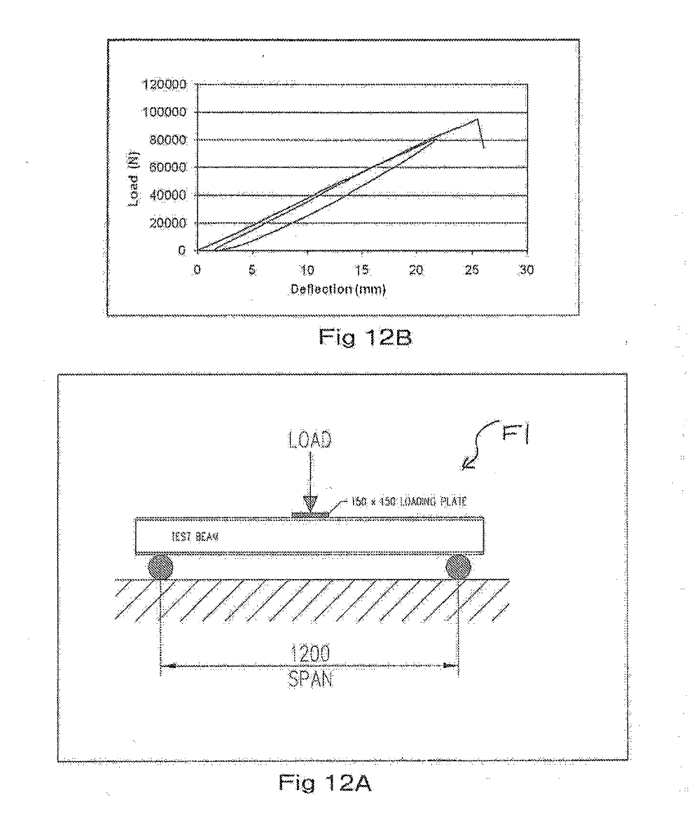

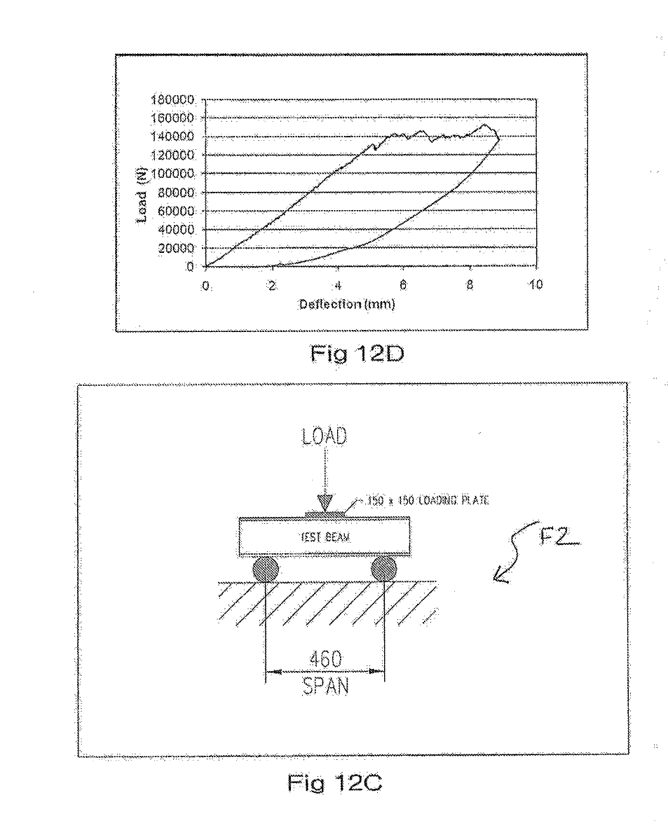

Panel 004 was furthermore tested to ascertain deflection as a result of load to a point of fracture. Testing apparatus F1 with a span length of 1200 mm for Panel 004 as illustrated in FIG. 12A was utilised to carry out this test. FIG. 12B shows a graphical plot between load applied and resultant deflection. Compressive fracture was reported at a peak load of 95.18N with a peak deflection of 26.04 mm prior to fracture. Testing apparatus F2 with a smaller span length of 460 mm for Panel 004 as illustrated in FIG. 12C was also utilised to ascertain deflection as a result of load to a point of fracture at the smaller span length of 460 mm. FIG. 12D shows a graphical plot between load applied and resultant deflection. Compressive fracture was reported at a peak load of 152.72N with a peak deflection of 8.90 mm prior to fracture.

It is to be appreciated by a skilled person in the art that the invention is no way limited to specific materials such as resins, catalyst, fillers. The invention is also not limited to any specific material characteristics and the materials characteristics depicted in tables 1 to 3 are merely non-limiting examples of articles produced by employing the process as described herein.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A process for forming a composite article, comprising the steps of:
delivering resin to a mixer at a pre-set flow rate;
mixing the resin with a catalyst in the mixer to form a composite material;
delivering the composite material to a mould;
detecting variations in flow rate of the resin during delivery relative to a pre-set value of flow rate of the resin; and
controlling delivery of the resin to reduce the variations in flow rate of the resin during delivery.

2. The process according to claim 1 wherein, the variation includes a decrease in flow rate of the resin with reference to the preset flow rate value, wherein the decrease results in increasing the rate of delivering the resin.

3. The process according to claim 1, wherein the variation in flow rate of the resin is detected by sensing fluctuations in head pressure developed during the delivering of the composite material.

4. The process according to claim 1, including movably positioning the mould relative to the composite material that is being delivered from the mixer to the mould.

5. The process according to claim 1 further including heating the composite material contained in the mould to a polymerisation temperature to facilitate curing of the composite material to thereby form the composite article.

6. The process according to claim 5 further including controlling the temperature of the composite material contained in the mould around the polymerisation temperature to effect curing.

7. The process according to claim 1 including sequentially cooling the composite material contained in the mould.

8. The process according to claim 1 including applying a mould-release coating on a surface of the mould sequentially before the step of delivering the composite material into the mould.

9. The process according to claim 1 further including releasing the composite articles formed in the mould.

10. The process according to claim 1 further comprising:
cutting the composite article by contacting the composite article with at least one cutting edge; and
piercing the composite articles with the at least one cutting edge to form a plurality of cuts extending along a width of the composite article.

11. A resin flow control system comprising:
a selector to set a value corresponding to a pre-set flow rate for delivering resin to a mixing chamber;
a sensor to detect variations in flow of resin relative to the pre-set flow rate of resin; and
a controller to receive a signal from the sensor and control the flow rate of the resin to minimise the variation from the pre-set flow rate.

12. A resin flow control system according to claim 11 wherein the resin is mixed with a catalyst to form a composite material in the mixing chamber, and wherein the composite material is delivered to a mould.

13. A resin flow control system according to claim 12 wherein the variations in flow of resin are detected by sensing fluctuations in head pressure developed during the delivery of the composite material to the mould.

14. (canceled)

15. A composite article moulding apparatus for forming a composite article, the apparatus comprising:
a mixing chamber for mixing a resin and a catalyst to form a composite material;
a pump for pumping the resin to the mixing chamber;
a delivery mechanism for releasing the composite material from the mixing chamber to a mould;
a detector for detecting and signalling variation of flow rate of resin with reference to a pre-set flow rate of resin;
a controller for controlling the rate of delivery of the resin;
wherein the controller is adapted to receive a signal of the variation from the detector and affect a change in rate of delivery of the resin to reduce the variation of the flow rate of resin.

16. The apparatus according to claim 15 wherein the variations in flow of resin are detected by sensing fluctuations in head pressure developed during the delivery of the composite material to the mould.

17.-19. (canceled)

20. The apparatus according to claim 15 wherein the delivery mechanism is movable across a width of the mould, and wherein the mould is conveyed in a plane that is substantially perpendicular to a plane of movement of the delivery mechanism.

21. (canceled)

22. The apparatus according to claim 15 further including an applicator assembly for applying a release agent to the mould.

23. The apparatus according to claim 15 further including a mould release assembly to facilitate release of the composite article from the mould.

24.-27. (canceled)

28. A dispenser for delivering a composite material composed of a first component and a second component, the dispenser comprising:
a first passage for conveying the first component from a first inlet into a mixing chamber;
a second passage for conveying the second component from a second inlet into a mixing chamber;
a valve assembly to prevent flow of the first component and/or the second component into the first passage; and
a biasing mechanism to provide a bias to the valve assembly, wherein in a neutral position the biasing mechanism provides a bias in a biasing direction against the direction of flow of the first component from the inlet into the mixing chamber.

29.-31. (canceled)

32. A composite article when formed by a process according claim 1.
